(19) United States
(12) Patent Application Publication
(10) Pub. No.: US 2015/0034618 A1
(43) Pub. Date: Feb. 5, 2015

(54) WELDING APPARATUS COMPRISING A WELDING ASSISTANCE

(71) Applicant: FRONIUS INTERNATIONAL GmbH, Pattenbach (AT)

(72) Inventors: Harald LANGEDER, Pettenbach (AT); Manfred WITTMANN, Rutzenmoos (AT)

(21) Appl. No.: 14/452,115

(22) Filed: Aug. 5, 2014

(30) Foreign Application Priority Data
Aug. 5, 2013 (AT) A201300628

(51) Int. Cl. B23K 9/095; G10L 15/22; G06F 3/16

(52) U.S. Cl. CPC B23K 9/0953; G06F 3/167; G10L 15/22; G10L 2015/223
USPC 219/130.21; 219/130.1; 219/137 R

(57) ABSTRACT

A welding apparatus comprises a welding unit for welding a workpiece. The welding unit comprises a welding assistance system for generating control commands by evaluating a voice dialogue performed with a welder, and a weld control unit for setting weld control parameters in dependence upon the control commands. A welding system includes a plurality of such welding apparatuses, wherein the welding assistance system is connected to the weld control units of the welding apparatuses via a data network. A method for welding a workpiece by means of a welding unit comprises providing a welding assistance system, evaluating a voice dialogue performed with a welder operating the welding unit, producing control commands for a weld control unit, and setting weld control parameters in dependence upon the produced control commands.

The invention relates to an apparatus and a method for welding a workpiece with the support of a welding assistance system.

A welding apparatus or welding device allows objects or workpieces to be materially bonded together through heat development, workpieces or components to be coated or a fixed homogeneous object or a workpiece to be broken up into several individual parts. Welding apparatuses can be used to process a wide variety of components or workpieces under the effect of heat, wherein the components can consist, for example, of metal or synthetic material. There are various types of welding devices, in particular autogenous welding devices, arc welding devices, gas-shielded metal-arc welding devices or even ultrasonic welding devices.

In arc welding, an arc is produced between a wire electrode and the workpiece to be welded. The workpiece is heated by the arc and the wire electrode is fused. The arc can be produced by applying direct or alternating current. The electric arc between the consumable wire electrode, as weld material, and the workpiece is used as a heat source for welding. Owing to the high temperature of the arc, the material is fused at the welding point. Welding current transformers with or without welding rectifiers, welding converters or welding inverters can be used as welding power sources. Depending upon the application and type of electrode, direct current or alternating current can be supplied to the consumable wire electrode. The consumption of the wire electrode is preferably compensated for by being permanently updated such that the length of the arc remains approximately constant.

In gas-shielded metal-arc welding, a protective gas additionally protects the welding point against the effect of the surrounding atmospheric air. In particular, oxidation of the welding point can be prevented by such a protective gas. A consumable wire electrode as weld material is also used in the case of gas-shielded metal-arc welding. The protective gas protects the liquid metal beneath the arc against oxidation, in which case the weld seam on the workpiece would be weakened. The consumable material on the wire electrode passes drop-wise onto the workpiece and melts at that location to form a weld seam. The protective gas flows from a nozzle surrounding the wire electrode or the welding wire and thus protects the arc and the weld pool against the atmospheric ambient air. The supplied welding wire can be uncoiled, for example, from a supply coil and is typically conveyed by a guide hose.

In spot welding, a weld connection is produced by locally introducing heat without an arc, as is generally known from the prior art.

A common feature in the different welding apparatuses or welding devices is that a welding unit is actuated, when welding a workpiece, via a weld control unit which outputs one or more weld control parameters to the welding unit, wherein the weld control unit is operated by a welder or user via a user interface on the welding apparatus. The user interface can be used to set different weld control parameters and optionally also display same. A welding process is implemented on the workpiece according to the set weld control parameters. For example, a user can input different functions using function keys. Welding of objects or workpieces generally requires, in the case of conventional welding devices, the user or welder to have a great deal of experience in order to correctly produce a weld seam. It is thus necessary for a user or welder to be taught about different welding processes or welding procedures. Despite considerable amount of time and effort spent on training, it is in many cases not possible in the case of conventional welding apparatuses to provide the user or welder with the required knowledge in the time available in order for him to produce an appropriate weld seam. In particular, with the different welding processes which are to be implemented by the same welder or user, it is difficult to provide a welder or user with the required knowledge to implement the different welding processes with a justifiable expense within a justifiable time. Even experienced welders with a relatively high level of knowledge also make avoidable errors when welding with conventional welding devices or welding apparatuses. With conventional welding apparatuses, the quality of each welded workpiece is thus variable, and in many cases is too low, depending upon the level of knowledge and experience of the welder. This is also the case owing to the wide variety of welding applications and the considerable external influences on the welding process.

There is a need to provide an apparatus and a method for welding a workpiece in which sufficient quality of the welded workpiece can be ensured even in the case of users with little knowledge and experience.

The invention thus provides a welding apparatus comprising a welding unit for welding a workpiece which is operated by a welder, and having a weld control unit which sets weld control parameters of the welding unit in dependence upon control commands which are generated by a welding assistance system by evaluating a voice dialogue and/or gestures performed by the welding assistance system with the welder.

In addition to a general increase in quality of the workpiece to be welded in the welding process, the welding apparatus in accordance with the invention additionally offers the advantage that the variation or variance quality of the produced welded workpieces is reduced. The welded workpieces thus have a more uniform quality than is possible with conventional welding devices. It is likewise advantageous that the welder is additionally also trained. Furthermore, it is advantageous that the welding assistance system can differentiate or recognise the level of welding knowledge which the user has and/or whether or not the user knows how to use the device. This means that, for example, a user can be a professional in terms of welding knowledge but does not know how to use the welding device or is not familiar with the operation thereof. The support by the welding assistance system is adapted accordingly.

In a possible embodiment of the welding apparatus in accordance with the invention, the welding assistance system is connected to a voice recognition unit.

In a possible embodiment, the voice recognition unit recognises, via a microphone connected thereto, a naturally spoken voice of the welder which implements the welding procedure or welding process.

In a further possible embodiment of the welding apparatus in accordance with the invention, the welding assistance system is connected to a welder database in which the level of knowledge of different welders in terms of a welding process to be performed on the workpiece is stored.

In a further possible embodiment of the welding apparatus in accordance with the invention, the identity of the welder, who is welding the workpiece to be processed in the welding process, is recognised by the welding assistance system using the naturally spoken voice spoken into the microphone.

In an alternative embodiment of the welding apparatus in accordance with the invention, the identity of the welder who is welding the workpiece to be processed in the welding process is recognised or input into the welding assistance system via a user interface of the welding apparatus.

In a further possible embodiment of the welding apparatus in accordance with the invention, the voice dialogue performed with the welder or user is controlled by the welding assistance system in dependence upon the level of knowledge of the respective welder, which level is read out from the welder database by the welding assistance system.

In a possible embodiment of the welding apparatus in accordance with the invention, the welding assistance system is connected to at least one loudspeaker, via which the welding assistance system outputs, to the welder, voice fragments or voice sequences generated according to the voice dialogue being performed in a controlled manner.

In a possible embodiment of the welding apparatus in accordance with the invention, the voice fragments of the voice dialogue being performed in a controlled manner are generated in dependence upon keywords which are recognised by the welding assistance system when evaluating the voice dialogue performed with the welder.

In a possible embodiment of the welding apparatus in accordance with the invention, a voice fragment output to the welder includes a command for the welder or a recommendation for the welder to perform an action during the welding process.

In a further possible embodiment of the welding apparatus in accordance with the invention, the voice fragment generated by the welding assistance system contains a question for the welder regarding a property or state of the workpiece to be processed or of the welding process.

In one further possible embodiment of the welding apparatus in accordance with the invention, the welding process performed on the workpiece is monitored by sensors of the welding apparatus which provide sensor data which indicate the current state of the welding process and/or of the workpiece.

In a further possible embodiment of the welding apparatus in accordance with the invention, the welding assistance system evaluates the sensor data obtained from the sensors and generates, on the basis of the evaluated sensor data, voice fragments for the voice dialogue performed with the welder and/or control commands for the weld control unit which sets control parameters of the welding unit in dependence upon the generated control commands.

In a further possible embodiment of the welding apparatus in accordance with the invention, the welding assistance system is integrated in a housing of the welding apparatus.

In a further possible embodiment of the welding apparatus in accordance with the invention, the welding assistance system is connected to the weld control unit of the welding apparatus via a wireless or wired interface and a data network.

In a further possible embodiment of the welding apparatus in accordance with the invention, a weld control parameter output by the weld control unit is read out from a stored characteristic curve—which indicates a function of the respective weld control parameter in dependence upon at least one input variable—in dependence upon the least one input variable and is output to the welding unit, wherein the input variable for the characteristic curve is contained in a control command which is generated by the welding assistance system by evaluating the voice dialogue performed with the welder and is output to the weld control unit.

In a possible embodiment of the welding apparatus in accordance with the invention, the weld control parameters can be set by the weld control unit.

The invention further provides a method for welding a workpiece by means of a welding unit, wherein a voice dialogue performed with the welder operating the welding unit is evaluated by a welding assistance system for producing control commands for a weld control unit which sets weld control parameters of the welding unit in dependence upon the produced control commands.

Possible embodiments of the welding apparatus in accordance with the invention and of the method, in accordance with the invention, for welding a workpiece by a welding unit will be explained in more detail hereinafter with reference to the accompanying figures, in which:

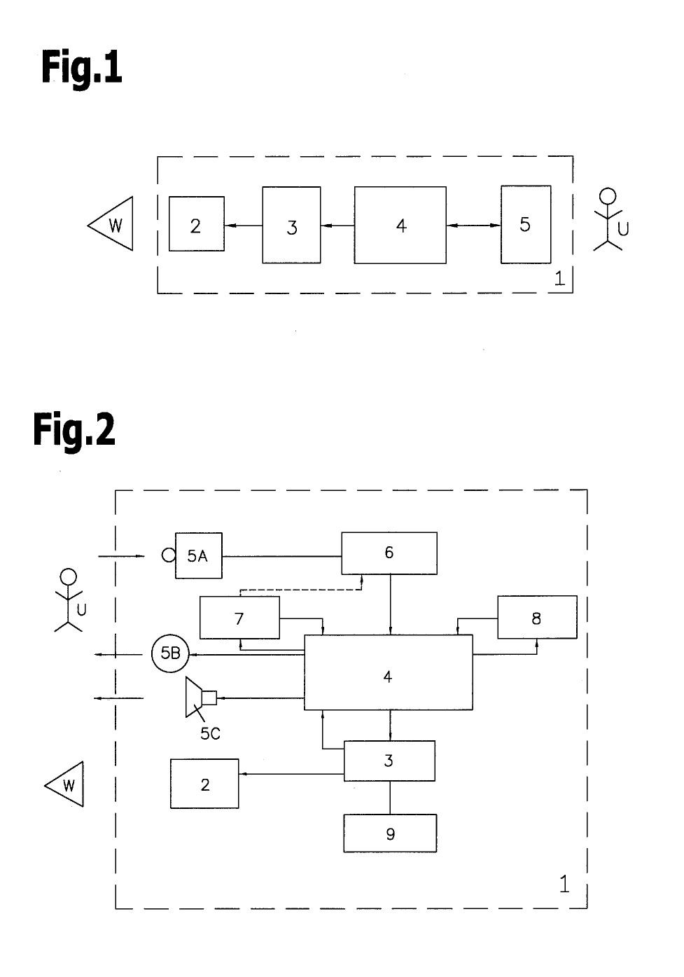

FIG. 1 shows a block diagram for illustrating a possible embodiment of the welding apparatus in accordance with the invention;

FIG. 2 shows a further block diagram for illustrating a further exemplified embodiment of the welding apparatus in accordance with the invention;

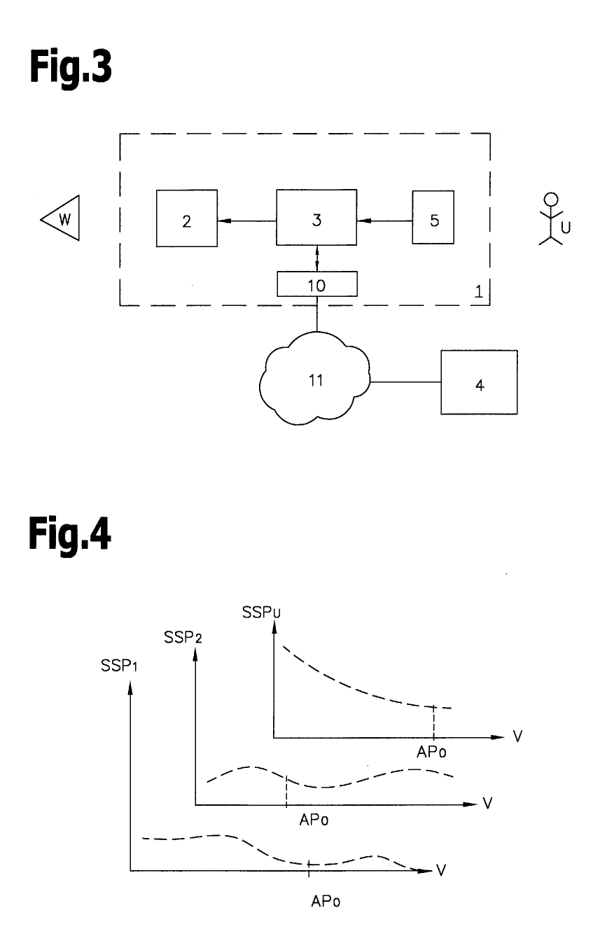

FIG. 3 shows a further block diagram for illustrating a further exemplified embodiment of the welding apparatus in accordance with the invention;

FIG. 4 shows diagrams for explaining the mode of operation of a possible implementation of the welding apparatus in accordance with the invention;

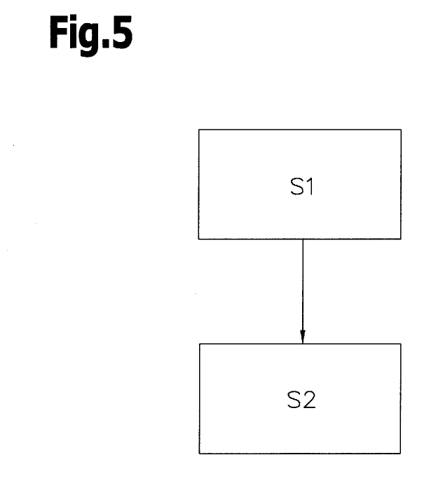

FIG. 5 shows a simple flow diagram for illustrating a possible embodiment of the method, in accordance with the invention, for welding a workpiece.

As can be seen in FIG. 1, a welding apparatus 1 in accordance with the illustrated exemplified embodiment comprises several units. The workpiece W to be welded by the welding apparatus 1 is indicated symbolically in FIG. 1 by a triangle. The welding apparatus 1 has a welding unit 2 for welding the workpiece W. The welding apparatus 1 is operated by a welder or user U who welds the workpiece W in a welding procedure. The welding unit 2 can be, for example, a welding torch. In one possible embodiment, the welding torch can be connected to the weld control unit 3 of the welding apparatus 1 via a mechanical coupling element and a cable-hose assembly. The weld control unit 3 is used to set weld control parameters SSP of the welding unit 2 so that welding can be performed using the welding torch. These weld control parameters SSP are, for example, at least a weld power and/or a welding wire advance and/or an arc length and/or a type of protective gas and/or an amount of protective gas and/or a weld speed. The weld control unit 3 can contain in particular a power source controller which sets an electric direct or alternating current output to the welding unit 2.

In the exemplified embodiment illustrated in FIG. 1, in the welding apparatus 1 in accordance with the invention, one or more weld control parameters SSP set by the weld control unit 3 are set inter alia in dependence upon control commands or instructions which are generated by a welding assistance system 4 of the welding apparatus 1. These control commands are produced or generated by the welding assistance system 4 by evaluating a voice dialogue performed with the welder U by the welding assistance system 4 via an interface 5. The weld control parameters SSP can also be set via a conventional operating unit of the welding apparatus 1. The weld control parameters SSP can thus be set via the voice dialogue in addition to via an operating unit. Accordingly, both setting options can also be active.

Accordingly, the welding assistance system 4 must be activated. This occurs for example in that an operating element is actuated on the operating unit, a button is pressed on the welding torch, a defined movement is performed with the welding torch, thereby identification takes place at the welding apparatus, and/or the like.

Essentially, the welding assistance system 4 can be deactivated, or the voice dialogue can be restarted, in the same manner if, for example, the voice dialogue does not provide the desired result or false information was inadvertently given or similar conditions are present.

In the welding apparatus 1, the welding assistance system 4 performs a targeted or guided voice dialogue with the welder U, wherein the welding assistance system 4 preferably has a memory in order to note or store correlations in the course of the voice dialogue and to incorporate these detected correlations in the voice outputs directed to the user U. The welding assistance system 4 supports or assists the user U as he performs his welding activity on the workpiece W. The welding assistance system 4 evaluates the voice dialogue performed with the welder U and generates corresponding control commands for the weld control unit 3. The latter sets the weld control parameters SSP of the welding unit 2 in dependence upon the received control commands.

In one possible embodiment, the welding assistance system 4 illustrated in FIG. 1 is connected to a welder database in which the level of knowledge of different welders or users U regarding a welding process or welding procedure to be performed on the workpiece W is stored. The welder database can be located in a local data memory of the welding apparatus 1 or in a database connected to the welding apparatus 1 via a data network. In one possible embodiment of the welding apparatus 1 in accordance with the invention, the identity of the welder or user U, who is welding the workpiece W to be processed in the welding process or welding procedure, is input via the user interface 5. The information is input, for example, such that the user U is recognised via an ID card, password or the like. In one possible implementation, the user U is additionally authenticated with respect to the welding apparatus 1 and then optionally also authenticated with respect to the welding procedure. In a further possible embodiment of the welding apparatus 1 in accordance with the invention, the identity of the welder or user U, who is welding the workpiece W to be processed in a welding process or welding procedure, is recognised by the welding assistance system 4 using a naturally spoken voice spoken into a microphone. For this purpose, the welding assistance system 4 is connected to a voice recognition unit which recognises the voice, spoken naturally into a microphone, of the welder or user U, i.e., using voice parameters. After the identity has been recognised, authorisations for setting the welding apparatus 1 can be granted accordingly.

The welding assistance system 4 recognises the identity U-ID of the welder or user U and determines therefrom, using the welder database, the respective level of knowledge of the user or welder U regarding the welding process or welding procedure to be performed on the workpiece W. The welding assistance system 4 recognises, for example, whether the user U is an experienced welder or a beginner. In one possible embodiment of the welding apparatus 1 in accordance with the invention, the voice dialogue performed with the welder or user is controlled by the welding assistance system 4 in dependence upon the level of knowledge of the respective welder. The level of knowledge is adapted during and/or after the voice dialogue and stored accordingly in the welder database. For example, a different voice dialogue is performed with an experienced welder U1 than with an inexperienced welder or beginner U2. A voice dialogue with an experienced welder U1 is mostly more precise and shorter than a voice dialogue with an inexperienced welder U2. In one possible embodiment, the welding assistance system 4 outputs voice fragments acoustically to the user or welder U via a loudspeaker or headset provided on the user interface 5, which voice fragments are generated by the welding assistance system 4 in accordance with the voice dialogue being performed in a controlled manner. The generated voice fragments of the voice dialogue being performed in a controlled manner are preferably generated in dependence upon keywords which are recognised by the welding assistance system 4 when evaluating the voice dialogue performed with the welder or user U. Accordingly, at least the level of knowledge regarding welding—i.e., an experienced welder or a beginner—and/or the welding apparatus 1—i.e., whether or not the welder knows how to use the device—are used as keywords. For example, the classification as to whether or not the welder knows how to use the device is performed using the designation for the parameters and/or states which is mostly dependent upon the device manufacturer. The generated voice fragments output to the welder or user U can include, for example, commands or recommendations or questions directed towards the welder U. The commands or recommendations can include, for example, recommendations to perform an action or not to perform an action before and/or during and/or after the welding process or welding procedure. However, recommendations relating to maintenance work can also be output, which can also have an influence on the welding process. For instance, a change in the contact tube in the welding torch may be recommended. The questions to the welder U comprise, for example, questions regarding a property and/or state of the workpiece W to be processed or of the welding process.

In one possible embodiment of the welding apparatus 1 in accordance with the invention, as illustrated in FIG. 1, the welding process performed on the workpiece W is monitored by sensors of the welding apparatus 1. These sensors provide sensor data which indicate or display the current state of the welding process or welding procedure and/or of the workpiece W. In one possible embodiment of the welding apparatus 1 in accordance with the invention, the welding assistance system 4 evaluates the sensor data obtained from the sensors and generates, on the basis of the evaluated sensor data, voice fragments for the voice dialogue performed with the welder U whilst taking into account the level of knowledge of the welder U. Furthermore, in one possible embodiment, the welding assistance system 4 can additionally generate control commands for the weld control unit 3 on the basis of the evaluated sensor data, which commands accordingly set weld control parameters SSP of the welding unit 2.

In the exemplified embodiment illustrated in FIG. 1, the welding assistance system 4 is integrated in a housing of the welding apparatus 1. In an alternative embodiment, the welding assistance system 4 can also be connected to the weld control unit 3 via a data network on an interface.

In one possible embodiment, the weld control unit 3 has access to a memory in which one or more characteristic curves for weld control parameters SSP are located. These weld control parameters SSP are, for example, a weld power, a welding wire advance, an arc length, a type of protective gas, an amount of protective gas, a weld speed, a base material, a welding wire diameter and/or further known parameters. The characteristic curves for different weld control parameters SSP located in the characteristic curve memory are illustrated schematically in FIG. 4. The characteristic curves each represent a function of a weld control parameter SSP in dependence upon at least one input variable. The characteristic curves illustrated in FIG. 4 are two-dimensional characteristic curves, in which in each case a weld control parameter SSP is determined by a variable V. In alternative embodiments, multi-dimensional characteristic curves or sets of characteristic curves can be stored in the memory, wherein a weld control parameter SSP is dependent upon several variables V. In one possible embodiment of the welding apparatus 1 in accordance with the invention, the variables V for one or more stored characteristic curves are extracted from a control command which the weld control unit 3 obtains from the welding assistance system 4. In one possible embodiment, this control command is generated by the welding assistance system 4 by evaluating the voice dialogue performed with the welder U and is then output to the weld control unit 3. For example, in a voice dialogue with the welding assistance system 4, a welder or user U can make comments, by speaking naturally, which allow the welding assistance system 4 to transfer one or more input variables V to the weld control unit 3 in a control command. For example, a welder or user U can indicate a weld advance of 5 m/min. This indication or comment, made by the welder or user U in the voice dialogue, is recognised as a relevant variable V by the welding assistance system 4, in particular using existing keywords. This indication is then output as an input variable V in a control command internally as an instruction to the weld control unit 3 which, using the input variable V, automatically sets a weld advance and different other or dependent weld control parameters SSP for the welding unit 2 using the stored characteristic curves. Accordingly, with one stored characteristic curve a large number of weld control parameters are set which are then adapted to the application and/or knowledge of the welder on the basis of the voice dialogue. In one possible embodiment, the original setting of the different input variables V can be effected using the identity U-ID of the welder U. In the characteristic curves illustrated in FIG. 4, e.g., a starting working point AP₀ for the different characteristic curves is set using the determined identity of the respective user or welder U. A deviation from the starting working point AP₀ can then be made during the welding procedure in each case in dependence upon the performed voice dialogue and the voice commands generated therefrom and also in dependence upon other input variables, e.g., sensor data. If, for example, a setting of the weld parameters which is favourable for the respective welding procedure is recognised by the welder or user U during the welding procedure using the quality of the weld seam, the welder/user can cause the setting of the different weld control parameters SSP to be a particularly suitable setting using a corresponding voice command and can store same in the memory for a further welding procedure and for subsequent welding processes. The starting working points AP illustrated in FIG. 4 for the different weld control parameters SSP can be set in dependence upon the recognised identity U-ID of the user U and additionally in dependence upon parameters or sensor data detected by the sensors, e.g., an ambient temperature T prevailing during the welding procedure.

In one possible embodiment of the welding apparatus 1 in accordance with the invention, the voice dialogue performed with the user U is logged or recorded by the welding assistance system 4. The recorded voice dialogue, performed during a welding procedure, can then be evaluated for determining user behaviour during the welding procedure. Furthermore, different sets of weld control parameters SSP and characteristic curves can be stored in a memory of the welding apparatus 1 for different materials of a workpiece W to be welded. The welding assistance system 4 follows the performed voice dialogue with the user and notes the user behaviour.

In one possible embodiment, the weld control unit 3, in particular a power source controller, transfers obtained sensor data and/or currently set weld control parameters SSP back to the welding assistance system 4. After obtaining sensor data and weld control parameters SSP, the welding assistance system 4 can vary the voice dialogue with the user U during the welding procedure. For example, in the event of critical sensor values or critical weld control parameters SSP, the welding assistance system 4 can output corresponding warnings or recommendations acoustically and/or optically to the welder U. The welding assistance system 4 additionally provides recommendations for welding and checks settings. Furthermore, in the event of erroneous or dangerous inputs or voice commands, the welding assistance system 4 can inform the welder U about the dangers and provide him with recommendations for more suitable settings with respect to individual weld control parameters SSP.

FIG. 2 shows a block diagram for one possible exemplified embodiment of the welding apparatus 1 in accordance with the invention. As can be seen in FIG. 2, the welding apparatus 1 comprises a welding unit 2 which is controlled by a power source controller 3. The power source controller 3 receives instructions or control commands from the welding assistance system 4. In the exemplified embodiment illustrated in FIG. 2, the welding assistance system 4 is connected to a voice recognition unit 6 which recognises the voice, spoken naturally into a microphone 5A, of the welder U. In the exemplified embodiment illustrated in FIG. 2, the voice recognition unit 6 outputs voice commands to the welding assistance system 4 for example in the form of metadata or data. The welding assistance system 4 is further connected to a welder database 7 in which the level of knowledge and wealth of experience of different welders or users U regarding a welding process to be performed on the workpiece W are stored. The welder database (welder info) can additionally supply parameters to the voice recognition unit 6 for voice recognition. In the exemplified embodiment illustrated in FIG. 2, the welding assistance system 4 is additionally connected to a databank or database 8 in which the current state of the welding procedure or welding process (session info) can be stored. During this welding procedure or welding process, the welding assistance system 4 has access to the databank 8. During the voice dialogue, the welding assistance system 4 can acoustically output voice fragments to the welder or user via a loudspeaker 5C. Furthermore, the welding assistance system 4 can provide information to the welder or user U via other output units, e.g., indicator lights or optical displays 5B. For example, the characteristic curves, illustrated in FIG. 4, of relevant currently set weld control parameters SSP can be displayed to the welder or user during the welding procedure. The microphone 5A, the optical display 5B and the loudspeaker 5C are part of the user interface 5 illustrated in FIG. 1. In the exemplified embodiment illustrated in FIG. 2, a sensor system 9 is connected to the weld control unit or power source controller 3, which sensor system supplies sensor data to the weld control unit 3. The sensor system 9 can also be connected to at least one further component of the welding apparatus 1. These sensor data can be relayed by the weld control unit 3 to the welding assistance system 4. In one possible embodiment, the welding assistance system 4 evaluates the sensor data obtained from the sensors and generates, on the basis of the evaluated sensor data, voice fragments for the voice dialogue performed with the welder U. Furthermore, the welding assistance system 4 can also generate control commands in response to the sensor data and output same to the weld control unit 3 as instructions. The sensor data supplied by the sensors 9 can indicate the current state of the workpiece W or of the welding procedure or welding process. Furthermore, the sensor data can also include parameters regarding the ambient conditions such as, for example, the ambient temperature.

FIG. 3 shows a further exemplified embodiment of a welding apparatus 1 in accordance with the invention. In the exemplified embodiment illustrated in FIG. 3, the weld control unit 3 is connected to a remote welding assistance system 4 via a data interface 10 and a data network 11. The interface 10 can be a wireless or wired interface. The data network 11 can be, for example, a local operating network of an automation system. Furthermore, the data network 11 can also be an extensive data network, e.g., the Internet. In this embodiment variant, the welding assistance system 4 can be implemented on one or more servers. In one further possible embodiment, several welding apparatuses 1 are connected to a common welding assistance system 4 via a data network 11.

FIG. 5 shows a flow diagram for illustrating a simple exemplified embodiment of the method in accordance with the invention in conjunction with FIGS. 1 to 4. In a first step S1, a voice dialogue performed with the welder or user U is evaluated by the welding assistance system 4 for producing control commands for the weld control unit 3. In a further step S2, the weld control parameters SSP of the welding unit 2 are set in dependence upon control commands which were generated by the welding assistance system 4 in step S1.

The welding procedure can be supported by a voice dialogue using the welding apparatus 1 in accordance with the invention and the welding method in accordance with the invention, the voice dialogue being performed by the welding assistance system 4 with the user U during the welding procedure. By way of example, a corresponding dialogue can be performed, for example, as follows. A welder or user U first states that the workpiece he wishes to weld is an aluminium sheet having a thickness of approximately 1.5 mm. In response to this, the welding assistance system 4 asks him which alloy the aluminium sheet comprises. The welder U states the alloy. In response to this, the welding assistance system 4 points out to the welder that for this alloy the suitable characteristic curve is to be selected. It also optionally provides the welder or user U with the instruction on how to set the characteristic curve for the respective alloy on the user interface 5 of the welding apparatus 1. In addition to this instruction, the welding assistance system 4 can additionally ask the welder how large the wire diameter is. The welder U can answer, for example, that the wire diameter is 1 mm. In response, the welding assistance system 4 provides the power source controller 3 with an instruction or control command in order to set or select the corresponding weld control parameter SSP. After selecting or choosing the weld control parameter SSP, the welding assistance system 4 can ask the welder in response which protective gas is to be used. If the welder U is unsure as to the type of protective gas, he can, for example, ask the welding assistance system 4 which protective gas is suitable, for example, in the case of aluminium. The welding assistance system 4 recognises the question and provides a suitable response that, for example, the protective gas must in every case be an inert gas, wherein this inert gas can include, for example, argon, argon-helium mixtures or special gases such as nitrogen. In response to this, the user or welder U can select the protective gas which appears to him to be suitable and, for example, can select argon as the protective gas. In a further step, the welding assistance system 4 can then select a suitable characteristic curve for this protective gas.

After this introductory voice dialogue, the actual welding procedure or welding process can begin. If the welder or user U is not satisfied with the weld seam formed, he can complain about this to the welding assistance system 4. For example, the welder U can indicate which welding procedure has not worked, wherein he can provide the welding assistance system 4 with additional information, e.g., that spattering has occurred during the welding procedure and/or the weld seam has a peculiar colour, e.g., black. The welding assistance system 4 receives the information from the welder U that the weld seam is black and recognises from where the problem might possibly have arisen and provides a corresponding recommendation. For example, the welding assistance system 4 can instruct the welder that he must control the amount of gas and/or whether he is sure that he has turned on the protective gas. If, for example, the welder or user U recognises that he has inadvertently not turned on the protective gas, he can input a corresponding voice command through the microphone 5A and give the command that the protective gas be turned on. After the protective gas has been turned on, the welding assistance system 4 can instruct the user U that there is the option in the welding apparatus 1 to now control the amount of protective gas by pressing a gas-check button. Furthermore, an indication can be given that with the selected wire diameter of 1 mm an amount of protective gas of 10 to 12 l must be set. In response to this, the welder or user U can undertake the corresponding setting or acoustically instruct same to be performed and confirm same with the welding assistance system 4. The welding assistance system 4 can now provide the indication that the weld seam should now be correct and ask the user U to check same.

The voice dialogue performed between the welding assistance system 4 and the user U may be different depending upon the type of welding problem which has occurred. In another scenario, a user or welder U can, for example, inform the welding assistance system 4 during the welding procedure that the weld seam is rather black and not enough power is being provided. The welding assistance system 4 recognises the welding problem which has occurred from the input and asks the user U in response to control the torch position because the weld seam is black. Furthermore, the welding assistance system 4 instructs the user that the provided workpiece W, which consists of aluminium, is basically to be welded in a piercing welding position. The user or welder U can confirm the instruction and ask whether the power is now increased. In response, the welding assistance system 4 can generate the corresponding control command for the weld control unit 3 and inform the user U that the weld power was increased.

Should the weld seam possibly be improved as a result of this, the welder or user can inform the welding assistance system 4 that the weld seam now appears to be suitable from his point of view. The welding assistance system 4 can, for example, then once again instruct the user U that he must take care to use a piercing welding position and to further increase the power since the weld seam is possibly too cold.

Furthermore, the user U can determine by way of example that an end crater is too small and too little material is available. In response to this, the welding assistance system 4 indicates, for example, that the settings for start and end craters are controlled. If it is determined that the end crater time is switched off, then in response, for example, an end crater welding time and an end crater power are programmed. If, for example, the welder or user U recognises that in his opinion the weld seam is too wide, the welding assistance system 4 can instruct, for example, that in the case of a weld seam which is too wide it recommends that the weld speed be increased because presumably the welder U has been welding too slowly.

As can be seen from the voice dialogues described above by way of example, the welding assistance system 4 supports the user U during the welding procedure by evaluating the variable voice dialogue depending upon the situation, the quality of the weld seam thereby being increased. The voice dialogue performed with the user U can be performed in dependence upon the level of knowledge of the welder. The voice dialogue performed with a beginner may be considerably different from a voice dialogue with an expert or experienced welder. For example, a voice dialogue performed with an experienced welder is substantially more precise and shorter. A voice dialogue with an experienced welder U can be performed, for example, as follows. A welder or user indicates “4T4M”. The welding assistance system 4 acknowledges this input with the indication “set”. In response, the welder or user inputs a “four stroke” or “special four stroke”. The welding assistance system 4 responds with “four stroke is set”. In response, the welder U, for example, can state: “starting power 150% for 0.3 s”. In response, the welding assistance system 4 may make the comment that this is not possible with special four stroke. Furthermore, the welder U can indicate that he has set 15 l of argon as the protective gas. In response, the welding assistance system 4 comments that the protective gas is controlled and set to 15 l/min. As can be seen from the voice dialogue described above by way of example, the voice dialogue performed in the case of an experienced welder U is substantially more precise and productive.

The voice dialogue is performed preferably in dependence upon the level of knowledge of the respective welder or user U. In one possible embodiment, the welder U himself indicates his level of knowledge or his identity U-ID. In one further possible embodiment of the welding apparatus 1 in accordance with the invention, the welding apparatus 1 recognises, using the questions raised by the welder U and his behaviour during the welding procedure, whether the respective welder U is an experienced welder or a less experienced welder. If, for example, the welding assistance system 4 recognises during the welding procedure that the welder U is not an experienced welder, despite his indications to the contrary, then it can switch or correspondingly change the previous voice dialogue to a voice dialogue suitable for an inexperienced welder.

In one possible embodiment, the voice dialogue is performed in a natural language, e.g., German or English, selected by the welder U. In one further possible embodiment, the language is selected in dependence upon contextual data, e.g., in dependence upon the location of the welding apparatus 1. If, for example, the welding apparatus 1 is located in Austria, then German is selected as the dialogue language. If, for example, the welding apparatus 1 is located in India, then English is selected as the language of the voice dialogue.

In one possible embodiment, the microphone 5A illustrated in FIG. 2 and loudspeaker 5C illustrated in FIG. 2 can be located in a helmet worn by the welder or user. In this embodiment, the user U thus has both hands free for performing the welding procedure. Further variations of the welding apparatus 1 in accordance with the invention are possible. For instance, the voice signal received by the user U can, for example, be refined e.g., for soundsuppression in factory workshops. Also, the output acoustic signal can be adapted or amplified in dependence upon the sound level of the surroundings. In the exemplified embodiment illustrated in FIG. 2, the welding assistance system 4 can recognise, from the voice input, a question from the welder or user and search the Internet or data network for a corresponding answer. The welding assistance system 4 can be used by the welder to input a complete request regarding a welding procedure, e.g., “material AlMg5 with thickness of 3 mm and weld material with diameter of 1.5 mm” or the like. The correct setting or correct weld control parameters SSP are automatically set by the weld control unit 3 or power source. It is thus possible to indicate that welding has been performed but the weld seam is excessive and weld penetration is 20% too low. Using the welding assistance system 4, the weld control unit 3 automatically corrects corresponding values or the weld control parameters SSP.

Furthermore, by using the welding apparatus 1 in accordance with the invention it can be achieved that when manual welding has taken place with a welding torch, containing for example a position sensor, in particular a gyro sensor, the welding assistance system 4 can use the received positional data or sensor data to accordingly instruct the user or welder U whether the welding procedure needs to be performed in a somewhat more piercing manner or whether the welding procedure needs to be performed more slowly. Furthermore, the welder or user U has the option of asking the welding assistance system 4 of the welding apparatus for experience or tips, e.g., what has to be considered in the case of an aluminium welding procedure, in particular if, for example, an AlSi12 alloy is being welded.

In one possible embodiment of the welding apparatus 1 in accordance with the invention, the welding assistance system 4 has access to a jargon-specific lexicon or vocabulary used by welders U when welding. The voice input by the user includes the naturally spoken voice which, after voice recognition has taken place, is interpreted by the welding assistance system 4 regarding the syntax and semantics thereof. Recognised keywords from the specialist jargon can be recognised by the welding assistance system 4 for performing the voice dialogue. Furthermore, the voice dialogue can be performed by the welding assistance system 4 in dependence upon contextual data, e.g., the current position or the next welding step to be performed within the welding process. Further possible contextual data include, for example, a time indication which is generated by a timer of the welding apparatus 1. The welding assistance system 4 can apply voice dialogue models and agree upon further steps within the welding process with the user or welder within the voice dialogue. Furthermore, the welding assistance system 4 can access ontologies for the respective domain or the respective welding process. In one possible embodiment, the voice fragments read out by the welding assistance system 4 are formed from synthesised speech. It is furthermore possible that recorded messages are also output. In addition to the user U inputting purely voice commands, in one possible embodiment the user can additionally input commands into the welding apparatus 1 via a keyboard. In one possible embodiment, the welding assistance system 4 is implemented by daemon software. The welding apparatus 1 in accordance with the invention can be used to train in particular inexperienced welders or users U specifically for different welding procedures. The level of knowledge gradually increases with each welding procedure. Whilst a relatively long and laborious voice dialogue is performed with the user U for the first welding procedures, the voice dialogue also becomes more precise and shorter as the knowledge of the user increases. The welding apparatus 1 in accordance with the invention is suitable for a wide variety of welding devices, e.g., for arc welding devices.

1. A welding apparatus comprising:
a welding unit for welding a workpiece, the welding unit comprising
a welding assistance system for generating control commands by evaluating a voice dialogue performed with a welder, and
a weld control unit for setting weld control parameters in dependence upon the control commands.

2. The welding apparatus as claimed in claim 1, wherein the welding assistance system is connected to a voice recognition unit which recognises a naturally spoken voice via a microphone.

3. The welding apparatus as claimed in claim 2, wherein the welding assistance system is connected to a welder database in which the level of knowledge of different welders in terms of a welding process to be performed on the workpiece is stored.

4. The welding apparatus as claimed in claim 3, wherein the identity of the welder who is welding the workpiece to be processed in a welding process is recognised by the welding assistance system using the naturally spoken voice spoken into the microphone or is input into the welding apparatus via a user interface.

5. The welding apparatus as claimed in claim 4, wherein the voice dialogue performed with the welder is controlled by the welding assistance system in dependence upon the level of knowledge of the respective welder, and wherein the level of knowledge is read out from the welder database by the welding assistance system.

6. The welding apparatus as claimed in claim 1, wherein the welding assistance system outputs to the welder via at least one loudspeaker voice fragments generated according to the voice dialogue being performed in a controlled manner.

7. The welding apparatus as claimed in claim 6, wherein the generated voice fragments of the voice dialogue being performed in a controlled manner are generated in dependence upon keywords which are recognised by the welding assistance system when evaluating the voice dialogue.

8. The welding apparatus as claimed in claim 7, wherein a generated voice fragment output to the welder includes a command for the welder or a recommendation to perform an action during the welding process and/or a question for the welder regarding a property or state of the workpiece to be processed or of the welding process.

9. The welding apparatus as claimed in claim 1, further comprising sensors, wherein the welding process performed on the workpiece is monitored by the sensors for providing data which indicate the current state of the welding process and/or of the workpiece.

10. The welding apparatus as claimed in claim 9, wherein the welding assistance system evaluates the sensor data obtained from the sensors and generates, on the basis of the evaluated sensor data, voice fragments for the voice dialogue performed with the welder and/or control commands for the weld control unit for setting weld control parameters of the welding unit in dependence upon the generated control commands.

11. The welding apparatus as claimed in claim 1, wherein the welding assistance system is integrated in a housing of the welding apparatus or is connected to the weld control unit via a data network and a wireless or wired interface.

12. The welding apparatus as claimed in claim 10, wherein the weld control parameters can be set by the weld control unit.

13. A method for welding a workpiece by means of a welding unit, the method comprising the steps of:
providing a welding assistance system;
evaluating a voice dialogue performed with a welder operating the welding unit;
producing control commands for a weld control unit; and
setting weld control parameters in dependence upon the produced control commands.

14. A welding system including a plurality of welding apparatuses, each welding apparatus comprising:
a welding unit for welding a workpiece when operated by a welder, the welding unit comprising
a welding assistance system for generating control commands by evaluating a voice dialogue performed by the welding assistance system with the welder,
a weld control unit for setting weld control parameters in dependence upon the control commands,
wherein the welding assistance system is connected to the weld control units of the respective plurality of welding apparatuses via a data network.

15. The welding system according to claim 14, wherein the welding assistance system is connected to a voice recognition unit which recognises a naturally spoken voice via a microphone.

16. The welding system according to claim 15, wherein the welding assistance system is connected to a welder database in which the level of knowledge of different welders in terms of a welding process to be performed on the workpiece is stored.

17. The welding system according to claim 16, wherein the identity of the welder, who is welding the workpiece to be processed in a welding process, is recognised by the welding assistance system using the naturally spoken voice spoken into the microphone or is input into the welding apparatus via a user interface.

18. The welding system according to claim 17, wherein the voice dialogue performed by the welder is controlled by the welding assistance system in dependence upon the level of knowledge of the respective welder, and wherein the level of knowledge is read out from the welder database by the welding assistance system.

19. The welding system according claim 14, wherein the welding assistance system outputs to the welder, via at least one loudspeaker, voice fragments generated according to the voice dialogue being performed in a controlled manner, wherein the generated voice fragments of the voice dialogue being performed in a controlled manner are generated in dependence upon keywords which are recognised by the welding assistance system when evaluating the voice dialogue performed by the welder, and wherein a generated voice fragment output to the welder includes a command for the welder or a recommendation to perform an action during the welding process and/or a question for the welder regarding a property or state of the workpiece to be processed or of the welding process.

20. The welding system according to claim 14, wherein each of the welding apparatuses further comprise sensors for monitoring the welding process performed on the workpiece, the sensors providing sensor data which indicate the current state of the welding process and/or of the workpiece, and wherein the welding assistance system evaluates the sensor data obtained from the sensors and generates, on the basis of the evaluated sensor data, voice fragments for the voice dialogue performed with the welder and/or control commands for the weld control unit which sets weld control parameters of the welding unit in dependence upon the generated control commands.
